(19) United States
(12) Patent Application Publication
(10) Pub. No.: US 2025/0155745 A1
(43) Pub. Date: May 15, 2025

(54) DIGITAL REAR MIRROR DEVICE HAVING ANTI-GLARE FUNCTION AND CONTROL METHOD THEREOF

(71) Applicant: THINKWARE CORPORATION, Seongnam-si (KR)

(72) Inventors: Ho Kwan LEE, Seongnam-si (KR); Tae Hyeong KIM, Seongnam-si (KR); Hyun Jin BANG, Seongnam-si (KR); Hyun Chul CHO, Seongnam-si (KR); Sung Rak CHOI, Seongnam-si (KR); Mi Ryeong GO, Seongnam-si (KR)

(21) Appl. No.: 18/897,424

(22) Filed: Sep. 26, 2024

(30) Foreign Application Priority Data
Sep. 27, 2023 (KR) 10-2023-0130743
Sep. 27, 2023 (KR) 10-2023-0130838
Nov. 27, 2023 (KR) 10-2023-0166565
Sep. 26, 2024 (KR) 10-2024-0130960

(51) Int. Cl. G02F 1/1335; B60R 1/08; B60R 1/12; B60R 1/26; G02F 1/13357; G02F 1/1368; G09G 3/36

(52) U.S. Cl. CPC G02F 1/133502; B60R 1/088; B60R 1/12; B60R 1/26; G02F 1/13362; G02F 1/1368; G09G 3/3648; B60R 2001/1253; G02F 2203/02; G09G 2320/0626; G09G 2380/10

(57) ABSTRACT

Provided is a digital rear mirror device having an anti-glare function, the device including: a cover lens for transmitting light from the front; a backlight unit for providing light from the rear; a polarizing unit for aligning a light direction; a liquid crystal mirror unit for adjusting and reflecting the light transmission; a thin film transistor (TFT) array for providing an electrical signal required for implementing a display image or video; a drive switching unit for switching between the mirror mode and the LCD mode; and a control unit for adjusting the light transmittance and light reflectivity of the liquid crystal mirror unit by comparing light intensities measured by a plurality of light sensors installed at the vehicle.

### CROSS-REFERENCE TO RELATED APPLICATIONS

This claims the benefit under 35 U.S.C. § 119 of Korean Application Nos. 10-2023-0130743, filed Sep. 27, 2023; 10-2023-0130838, filed Sep. 27, 2023; 10-2023-0166565, filed Nov. 27, 2023; and 10-2024-0130960, filed Sep. 26, 2024; the disclosures of each of which are incorporated herein by reference in their entirety.

### TECHNICAL FIELD

The present disclosure relates to a digital rear mirror device having an anti-glare function and a control method thereof, and more particularly, to a vehicle digital rear mirror (DRM) device that may adjust the clarity and visibility of a screen by adjusting its transmittance and reflectivity by using a liquid crystal (LC) mirror, and a control method thereof.

### TECHNOLOGY BACKGROUND OF THE INVENTION

In recent years, technology development has been actively conducted to improve the safety and convenience of a vehicle, and among these developments, research on a digital rear mirror (DRM) device to secure rear visibility and inhibit driver glare is spotlighted. An existing vehicle rear mirror may use a physical mirror to show the rear, which may not sufficiently resolve the glare caused by a change in surrounding lighting, in particular, a headlight of a vehicle following behind when driving at night.

Meanwhile, an existing electronic chromic (EC) type digital rear mirror may include two polarizing mirrors including a low reflectivity outer surface mirror and a high reflectivity inner mirror. This rear mirror may be generally operated like a general rear mirror as the high reflectivity inner mirror is in operation, and may be operated by changing an angle of the mirror inside the mirror to refract light when a sensor disposed in the middle of the mirror detects the brightness of light and then drives an electrochromic mirror (ECM) function based on the detected brightness of light. Here, a liquid or thin film including electrons may be disposed between two pieces of glass, and a color of the mirror may be changed based on a movement of the electrons when a current flows. However, when the ECM function is in operation, an appearance of the vehicle may not often be visible properly, and continuous ON/OFF changes may be impossible.

In addition, the existing EC type mirror may have a slow reaction speed because the mirror is operated based on a principle that the color of the mirror is changed by an electric signal. The existing EC type mirror may especially lack instantaneous anti-glare performance due to its difficulty in responding to a rapidly changing light condition and may have an inconsistent change in its transmittance or a slower response speed due to lower performance of an EC material over a long period of use.

In addition, the existing EC type mirror may have a limited color change range, which may not provide the optimal anti-glare performance under various light conditions, and have a limitation in finely adjusting its transmittance, especially in a dark environment.

In order to improve the above-described problems and overcome the limitations, a liquid crystal (LC) method has begun to be applied to the digital rear mirror. However, the technology development for the optimal device structure and an efficient control method thereof still remains insufficient.

### CONTENTS OF THE INVENTION

### Problems to be Solved

An object of the present disclosure is to provide a digital rear mirror device having improved anti-glare performance by applying a liquid crystal (LC) method to induce an immediate change in transmittance of light through an electric signal, and a control method thereof.

Another object of the present disclosure is to provide a digital rear mirror device capable of securing day and night visibility by finely adjusting its transmittance based on various light conditions through pulse width modulation (PWM) voltage adjustment, and a control method thereof.

### Means for Solving the Problem

According to an embodiment of the present disclosure, provided is a digital rear mirror device having an anti-glare function, which is capable of implementing a mirror mode for checking a state of the rear of a vehicle through reflected light and a liquid crystal display (LCD) mode for displaying an image or a video, the device including: a cover lens for transmitting light from the front; a backlight unit for providing light from the rear; a polarizing unit for aligning a light direction; a liquid crystal mirror unit for adjusting and reflecting the light transmission; a thin film transistor (TFT) array for providing an electrical signal required for implementing a display image or video; a drive switching unit for switching between the mirror mode and the LCD mode; and a control unit for adjusting the light transmittance and light reflectivity of the liquid crystal mirror unit by comparing light intensities measured by a plurality of light sensors installed at the vehicle.

The mirror mode may include a first mirror mode in which the anti-glare function is not implemented and a second mirror mode in which the anti-glare function is implemented, and the anti-glare function may be driven by lowering the light reflectivity of the liquid crystal mirror unit to below a predetermined value by the control unit.

The light sensor may include a front light sensor for detecting and measuring the intensity of light entering from the front of the vehicle, and a rear light sensor for detecting and measuring the intensity of light entering from the rear of the vehicle, and the control unit may control the first mirror mode and the second mirror mode to be selectively driven by comparing the light intensity measured by the front light sensor with the light intensity measured by the rear light sensor.

The control unit may control the first mirror mode to be driven when the light intensity measured by the rear light sensor is weaker or equal to the light intensity measured by the front light sensor, and control the second mirror mode to be driven when the light intensity measured by the rear light sensor is stronger than the light intensity measured by the front light sensor.

The light reflectivity of the liquid crystal mirror unit may be adjusted to 40% or more in the first mirror mode, and the light reflectivity of the liquid crystal mirror unit may be adjusted to less than 40% in the second mirror mode.

The light reflectivity of the liquid crystal mirror unit may be adjusted to be within a range of 10% or more and less than 40% in the second mirror mode.

The device may further include a liquid crystal mirror adjustment unit for adjusting the light transmittance and light reflectivity of the liquid crystal mirror unit, wherein the liquid crystal mirror adjustment unit is provided to adjust the light transmittance and light reflectivity of the liquid crystal mirror unit stepwise in a plurality of stages by using a pulse width modulation (PWM) control manner.

The drive switching unit may be controlled to automatically switch a drive mode from the mirror mode to the LCD mode by the control unit when receiving a reverse gear signal of the vehicle, and the TFT array may be controlled to form and transmit the video received from a rear camera installed at the rear of the vehicle to a lower part of a display screen of the digital rear mirror device by the control unit when the LCD mode is automatically switched by receiving the reverse gear signal of the vehicle.

According to an embodiment of the present disclosure, provided is a control method of a digital rear mirror device having an anti-glare function, which includes a liquid crystal mirror unit that uses a liquid crystal (LC) method, the method including: detecting light intensity from each of a front light sensor and a rear light sensor, installed at a vehicle; comparing the light intensity measured by the front light sensor with the light intensity measured by the rear light sensor; driving an anti-glare mode based on a light intensity comparison result; and adjusting reflectivity of the liquid crystal mirror unit.

The anti-glare mode may be controlled to be driven only when the light intensity measured by the rear light sensor is determined to be stronger than the light intensity measured by the front light sensor in the comparing of the light intensities, and the anti-glare mode may be implemented by lowering the reflectivity of the liquid crystal mirror unit to less than a predetermined value.

According to an embodiment of the present disclosure, provided is a control method of a digital rear mirror device having an anti-glare function, which includes a liquid crystal mirror unit that uses a liquid crystal (LC) method, and is capable of implementing a mirror mode for checking a state of the rear of a vehicle through reflected light and a liquid crystal display (LCD) mode for displaying an image or a video, the method including: receiving an LCD mode signal; outputting a streaming video; detecting light intensity from a front light sensor installed at the vehicle; comparing the light intensity measured by the front light sensor with a predetermined value; and adjusting display brightness of the streaming video based on a light intensity comparison result.

The display brightness may be controlled to be lower when the light intensity measured by the front light sensor is 500 lux or less, and the display brightness may be controlled to be increased when the light intensity measured by the front light sensor is 1,000 lux or more, in the comparing of the light intensities.

According to an embodiment of the present disclosure, provided is a digital rear mirror device having an anti-glare function, which includes a liquid crystal mirror unit that uses a liquid crystal (LC) method, a processor, and a memory unit, and further includes computer-executable instructions stored in the memory unit, wherein when executed by the processor of the device, the computer-executable instructions causes the digital rear mirror device to perform: an operation of detecting light intensities from a front light sensor and a rear light sensor installed at the vehicle; an operation of comparing the light intensity measured by the front light sensor with the light intensity measured by the rear light sensor; an operation of operating an anti-glare mode based on a light intensity comparison result; and an operation of adjusting reflectivity of the liquid crystal mirror unit. The anti-glare mode may be controlled to be operated only when the light intensity measured by the rear light sensor is determined to be stronger than the light intensity measured by the front light sensor in the comparing of the light intensities. The anti-glare mode may be implemented by lowering the reflectivity of the liquid crystal mirror unit to below a predetermined value.

According to an embodiment of the present disclosure, provided is a digital rear mirror device having an anti-glare function, which includes a liquid crystal mirror unit that uses a liquid crystal (LC) method, a processor and a memory unit, is capable of implementing a mirror mode for checking a state of the rear of a vehicle through reflected light and an LCD mode for displaying an image or a video, and further includes computer-executable instructions stored in the memory unit, wherein when executed by the processor of the device, the computer-executable instructions causes the digital rear mirror device to perform: an operation of receiving a liquid crystal display (LCD) mode signal; an operation of outputting a streaming video; an operation of detecting light intensity from a front light sensor installed at the vehicle; an operation of comparing the light intensity measured by the front light sensor with a predetermined value; and an operation of adjusting display brightness of the streaming video based on a light intensity comparison result. The display brightness may be controlled to be lower when the light intensity measured by the front light sensor is 500 lux or less, and the display brightness may be controlled to be increased when the light intensity measured by the front light sensor is 1,000 lux or more, in the comparing of the light intensities.

According to an embodiment of the present disclosure, provided is a computer-readable recording medium in which a computer program is recorded for executing a control method of a digital rear mirror device having an anti-glare function.

According to an embodiment of the present disclosure, provided is a computer program which includes a program code for executing a control method of a digital rear mirror device having an anti-glare function and is stored on the computer-readable recording medium.

### Effects of the Invention

The digital rear mirror device having the anti-glare function according to the embodiments of the present disclosure may include the liquid crystal mirror unit that uses the liquid crystal (LC) method, and may have the significantly improved response speed compared to the digital rear mirror that uses the existing electronic chromic (EC) method to thus immediately adjust the brightness based on the fast response speed to the external lighting change, thus rapidly inhibiting the driver glare, thereby minimizing the driver's eye fatigue.

Meanwhile, the digital rear mirror device according to the present disclosure may be provided to compare the light intensities respectively measured by the front light sensor and the rear light sensor to thus adjust the light transmittance and light reflectivity of the liquid crystal mirror unit, thereby implementing the anti-glare function, and adjust the anti-glare function stepwise in the plurality of stages by the light transmittance and light reflectivity of the liquid crystal mirror unit in the pulse width modulation (PWM) control manner, thereby providing the driver with improved driving convenience, and maximized visibility in various traffic situations.

In addition, the digital rear mirror device according to the present disclosure may control the liquid crystal arrangement in the pixel unit by precisely driving the TFT array to thus precisely display the rear video based on the surrounding light or the driving situation, thus allowing the driver to be always provided with the secured clear and sharp rear view, and the maximized visibility in the various environments such as day and night.

In addition, the digital rear mirror device according to the present disclosure may easily perform the switch between the general mirror mode and the LCD mode for streaming the image or the video, either manually or automatically, and automatically adjust the display brightness in the LCD mode based on the surrounding light, such as day or night and bright environment or the dark environment, thereby always maintaining the optimal field of vision without the driver's direct brightness adjustment.

### BRIEF DESCRIPTION OF DRAWINGS

FIG. 1 is a diagram showing a digital rear mirror device according to embodiments of the present disclosure.

FIGS. 2 and 3 are diagrams each showing an internal component of the digital rear mirror device according to embodiments of the present disclosure.

FIG. 4 is a configuration diagram showing a control system for the digital rear mirror device according to embodiments of the present disclosure.

FIGS. 5 and 6 are flowcharts each showing a control method of a digital rear mirror device according to embodiments of the present disclosure.

FIG. 7 is a block diagram showing a vehicle mounted with the digital rear mirror device according to embodiments of the present disclosure.

FIG. 8 is a block diagram showing a control device of the vehicle in FIG. 7.

### DETAILED DESCRIPTION

Hereinafter, specific embodiments of the present disclosure are described. A detailed description below is provided to facilitate a comprehensive understanding of a method, a device, and/or a system described in the specification. However, the embodiments are only described by way of examples and the present disclosure is not limited thereto.

In describing the embodiments of the present disclosure, omitted is a detailed description of a case where it is decided that the detailed description of the known functions or configurations related to the present disclosure may unnecessarily obscure the gist of the present disclosure. In addition, terms described below are defined in consideration of their functions in the present disclosure, and may be construed in different ways by intentions of users or operators, practices, or the like. Therefore, the terms should be defined on the basis of the contents described throughout the specification. Terms used in the detailed description are provided merely to describe the embodiments of the present disclosure, and should not be construed to be restrictive. A term of a single number may include its plural number unless explicitly indicated otherwise. It should be understood that terms “include”, “have”, or the like used in the specification specify certain features, numerals, steps, operations, elements, portions, or combinations thereof, and it should not be construed to exclude the presence or possibility of one or more other features, numbers, steps, operations, elements, portions, or combinations thereof other than those described.

In addition, terms “first”, “second”, A, B, (a), (b), and the like, may be used in describing components of an embodiment of the present disclosure. These terms are used only in order to distinguish any components from other components, and features, sequences, or the like of the corresponding components are not limited to these terms.

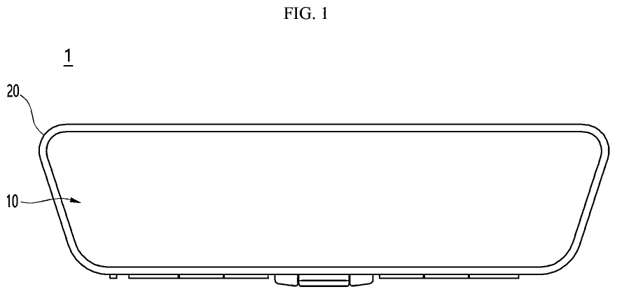

FIG. 1 is a diagram showing a digital rear mirror device according to embodiments of the present disclosure.

Referring to FIG. 1, a digital rear mirror device 1 according to embodiments of the present disclosure may include a display unit 10 and a rear mirror frame 20.

The digital rear mirror device 1 may be mounted in a vehicle and may be a mirror mounted to secure a driver's rear view.

The display unit 10 may be provided to reflect light to directly check the rear in a mirror mode, and output a rear video of the vehicle digitally in a liquid crystal display (LCD) mode to provide the driver with a secured field of vision appropriate for a situation. The display unit 10 may acquire video information on a front video and/or the rear video from a front camera and/or a rear camera, and output visual information through the display unit 10 based on the video information. The display unit 10 may include at least one of a liquid crystal display (LCD), a thin film transistor-liquid crystal display (TFT LCD), an organic light-emitting diode (OLED), a flexible display, a three-dimensional (3D) display, and an e-ink display.

The display unit 10 may be provided to use liquid crystal (LC) technology to perform rapid switching between the mirror mode and the LCD mode, and may perform the switching between the mirror mode and LCD mode automatically, or may be designed for the driver to easily switch the mode manually as needed.

The mirror mode may be a mode in which the display unit 10 is operated in a transparent state, and reflects light for the driver to check the rear like a traditional rear mirror.

In detail, in the mirror mode, the display unit 10 may have a film or a panel, built therein and made of glass or a reflective coated surface, and may be provided to use this configuration to thus reflect light entering from the rear as it is, like a physical mirror, thereby enabling the rear view to be easily checked.

The LCD mode may be a digital display mode in which a video captured by the front camera and/or the rear camera is displayed in real time.

In detail, in the LCD mode, the display unit 10 may be switched to an opaque state, may inactivate its physical mirror function, and may be controlled to digitally output the front video and/or the rear video through an LCD module built therein.

In the embodiments, the front video captured by the front camera in the LCD mode may be controlled to be output to an upper part of a screen of the display unit 10, and the rear video captured by the rear camera may be controlled to be output to a lower part of the screen of the display unit 10.

The rear mirror frame 20 may protect the display unit 10 from external impact or vibration, and function to firmly fix the device. The rear mirror frame 20 may be mounted with a configuration for supply an electrical signal and power to the display unit 10, and a manipulation button or a touch panel may be further installed for the driver to easily switch between the mirror mode and the LCD mode.

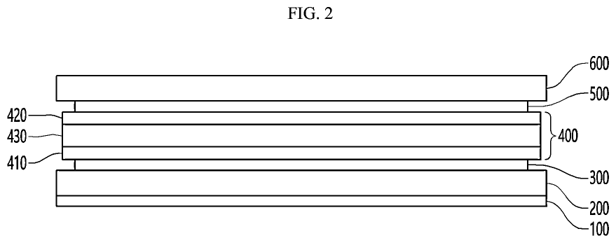

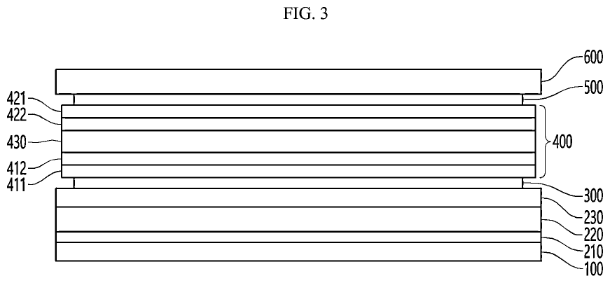

FIGS. 2 and 3 are diagrams each showing an internal component of the digital rear mirror device according to embodiments of the present disclosure.

The digital rear mirror device 1 described below may be the digital rear mirror device 1 capable of implementing the mirror mode for checking a state of the rear of the vehicle through reflected light and the LCD mode for displaying the image or the video. To describe in more detail, the internal component described with reference to FIGS. 2 and 3 may be a component included in the display unit 10 of the digital rear mirror device 1.

Referring to FIG. 2, the digital rear mirror device 1 according to the present disclosure may include a backlight unit 100 for providing light from the rear, a polarizing unit 300 or 500 for aligning a light direction, a liquid crystal mirror unit 400 for adjusting and reflecting light transmission, a thin film transistor (TFT) array 200 for providing the electrical signal required for implementing a display image or video, and a cover lens 600 for transmitting light from the front.

The backlight unit 100 may function to provide light (light source) from a rear side of the display unit 10, and may use an LED backlight unit for example. The backlight unit 100 may supply light to provide uniform lighting for a TFT-LCD screen to be seen clearly, and control the lighting to maintain consistent brightness and contrast.

The TFT array 200 may function to adjust transmittance of a liquid crystal by providing the electric signal necessary to control the liquid crystal. The TFT array 200 may include a plurality of transistors in the form of thin films disposed for each pixel, and precisely control the electric signal provided to each pixel within the display unit 10. Each of the transistors may be provided to adjust the transmittance of light by applying a voltage to each pixel to align liquid crystal molecules in a specific direction, thus causing the pixel to become brighter or darker, thereby forming the display image.

In detail, the TFT array 200 may control liquid crystal cells by supplying a correct voltage to the liquid crystal cells for the liquid crystals to be arranged in an appropriate direction for each pixel when displaying the video received from the rear camera on the rear mirror in the LCD mode. When the liquid crystals are arranged in the specific direction in response to the electric signal provided through the TFT array 200, light may be polarized based on the arrangement, and the video may appear on the screen. Through this process, the TFT array 200 may be provided to implement a clear rear video by precisely adjusting its brightness and color.

The liquid crystal mirror unit 400 may function to adjust the polarized light transmission and be provided to change a direction in which light is transmitted by the voltage. The liquid crystal mirror unit 400 may have a polymer-dispersed liquid crystal layer built therein, and the polymer-dispersed liquid crystal layer may be provided to transmit or block polarized light by rotating an orientation direction of the liquid crystal by the electronic signal, thereby controlling the brightness, light transmittance, light reflectivity, or the like of the screen.

In the embodiments, the liquid crystal mirror unit 400 may include a first indium tin oxide (ITO) glass 410, a second ITO glass 420, and a liquid crystal cell 430 interposed therebetween.

Each of the first and second ITO glasses 410 and 420 may be a transparent conductor made of indium tin oxide, transmit the electric signal to the liquid crystal display and simultaneously function to maintain the transmittance, and may be used as a transparent electrode that transfers the voltage to the liquid crystal cell 430 and transmits light.

The first or second ITO glass 410 or 420 may be provided in the mirror mode to allow the driver to see the rear through the mirror by transmitting light entering from the outside as it is without much interference, and provided in the LCD mode to transfer the electric signal provided from the TFT array 200 to the liquid crystal cell 430 to thus control implementation of the display.

The polarizing unit 300 or 500 may include the rear polarizing unit 300 disposed on a rear side of the liquid crystal mirror unit 400 and the front polarizing unit 500 disposed on a front side of the liquid crystal mirror unit 400.

The rear polarizing unit 300 may be provided to function to polarize light from the backlight unit 100 in the specific direction and provide the same to the liquid crystal mirror unit 400, and to transmit or block polarized light based on the electric signal through the liquid crystal mirror unit 400 to thus adjust the brightness and color of each pixel.

The front polarizing unit 500 may function to control light directly displayed to a user, that is, to polarize light and reduce external reflection to improve the clarity and image quality of the display.

Referring to FIG. 3, the TFT array 200 may have a thin film transistor 210, a color filter 220, and an LCD polarizing plate 230, which are sequentially stacked, and the liquid crystal mirror unit 400 may have a first polarizing unit 411, a first ITO glass 412, the liquid crystal cell 430, a second polarizing unit 421, and a second ITO glass 422 are sequentially laminated.

The thin film transistor 210 may be a transistor made of a very thin semiconductor material, may be connected to each pixel of an LCD panel, and may function to apply the voltage for the liquid crystal molecules of the pixel to be arranged in the specific direction to adjust the light transmission. In an embodiment, the thin film transistor 210 may include a source, a drain, and a gate electrode.

The color filter 220 may be a component for implementing the colors in an LCD display, and function to separate light transferred to the pixel into three colors of red (R), green (G), and blue (B).

The LCD polarizing plate 230 may function to control light entering the liquid crystal cell 430 by transmitting only polarized light from the backlight unit 100.

The first polarizing unit 411 may be an input polarizing plate disposed at the rear of the liquid crystal cell 430, and function to polarize light incident thereon. The first polarizing unit 411 may function to transmit only light vibrating in the specific direction before the backlight unit 100 or external light enters the liquid crystal cell 430, thereby allowing only polarized light to pass through the liquid crystal cell.

Each of the first ITO glass 412 and the second ITO glass 422 may function as the transparent electrode that conducts electricity and controls the arrangement of the liquid crystal molecules by transferring the voltage to the liquid crystal cell 430.

The liquid crystal cell 430 may be a layer including the liquid crystal molecules, and function to adjust the light transmission in response to the electric signal. The liquid crystal cell 430 may be provided to control a direction of polarized light by changing the arrangement of the liquid crystal molecules when an electric field is applied thereto, and in this process, the light transmittance may be changed, and the brightness and color of the pixel may be determined. In addition, when the voltage is applied to the liquid crystal cell 430, the liquid crystal molecules may be aligned to transmit or block light, thereby adjusting the brightness and contrast of the display. That is, the liquid crystal cell 430 may be a component for adjusting the light transmittance and the light reflectivity in response to the electric signal.

The second polarizing unit 421 may be an output polarizing plate disposed on the front of the liquid crystal cell 430, and function to control light transmitted from the liquid crystal cell 430 by polarizing light once again and finally outputting the same to the display unit 10.

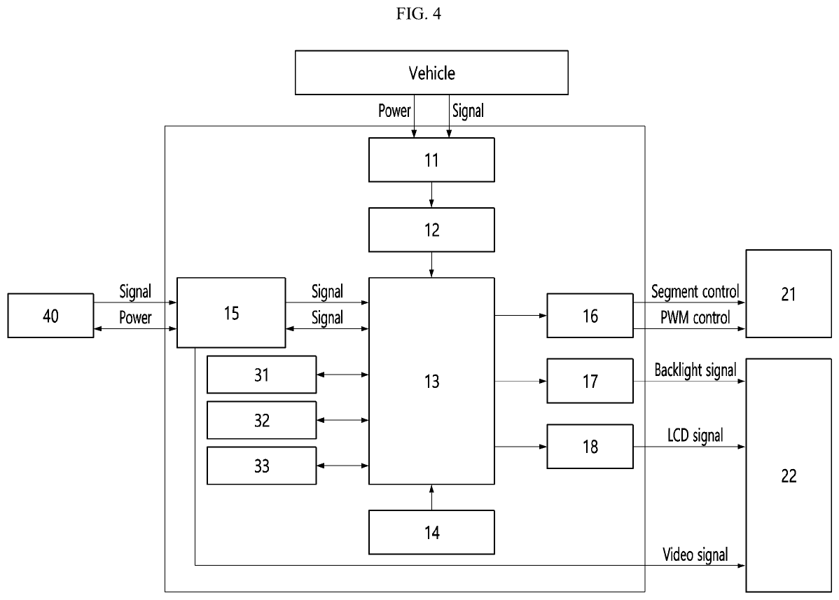

FIG. 4 is a configuration diagram showing a control system for the digital rear mirror device according to embodiments of the present disclosure.

Referring to FIG. 4, the control system for the digital rear mirror device according to the embodiments of the present disclosure may include a power supply unit 11 for receiving power from the vehicle and supplying the same, a power system 12 for distributing supplied power, and a control unit 13 for controlling the digital rear mirror device. Here, the power supply unit 11 and the power system 12 may also function to receive and supply various signals from the vehicle.

The control unit 13 may function to control the display unit 10 to implement either the mirror mode for checking the state of the rear of the vehicle may through reflected light or the LCD mode for displaying the image or the video.

Here, the mirror mode may include a first mirror mode in which an anti-glare function is not implemented and a second mirror mode in which the anti-glare function is implemented, and the anti-glare function may be driven by lowering the light reflectivity of the liquid crystal mirror unit 400 to below a predetermined value by the control unit 13.

In the embodiments, the control unit 13 may control the first mirror mode and the second mirror mode to be selectively driven by comparing light intensity measured by a front light sensor 31 with light intensity measured by a rear light sensor 32.

In detail, the control unit 13 may control the first mirror mode to be driven when the light intensity measured by the rear light sensor 32 is weaker or equal to the light intensity measured by the front light sensor 31. On the contrary, the control unit 13 may control the second mirror mode to be driven when the light intensity measured by the rear light sensor 32 is stronger than the light intensity measured by the front light sensor 31.

The light reflectivity of the liquid crystal mirror unit 400 may be adjusted to 40% or more in the first mirror mode, and the light reflectivity of the liquid crystal mirror unit 400 may be adjusted to less than 40%, for example, within a range of 10% or more and less than 40% in the second mirror mode.

The first mirror mode may be provided in a state in which the display unit 10 functions as a general mirror without supplying power or applying the voltage to the liquid crystal mirror unit 400, and the present disclosure is not necessarily limited thereto. That is, the first mirror mode may be in a state in which a tiny or small amount of voltage is applied to the liquid crystal mirror unit 400 for the display unit 10 to function as the general mirror, and the light reflectivity of the liquid crystal mirror unit 400 is lower by a specific value to achieve a visibility improvement purpose rather than an anti-glare purpose. As a result, the first mirror mode may be a step that refers to a state in which the light reflectivity of the liquid crystal mirror unit 400 is 40% or more, regardless of whether the voltage is applied to the liquid crystal mirror unit 400.

In an embodiment, the TFT array 200 may be controlled not to be driven while the first mirror mode or the second mirror mode is driven. The reason is that when the TFT array 200 is driven, the traditional mirror function is unable to be performed because the LCD mode is driven, in which the image or the video is output through the liquid crystal mirror unit 400.

The light sensor installed in the vehicle may include the front light sensor 31, the rear light sensor 32, and an internal light sensor 33. The front light sensor 31 may be a component installed on the front side of the vehicle and measuring the intensity of external light entering from a direction in which the vehicle drives, and the rear light sensor 32 may be a component installed on the rear side of the vehicle and measuring the intensity of external light entering from the rear of the vehicle, such as a headlight of a vehicle following behind. That is, the light sensor may include the front light sensor 31 for detecting and measuring the intensity of light entering from the front of the vehicle and the rear light sensor 32 for detecting and measuring the intensity of light entering from the rear of the vehicle. The internal light sensor 33 may be a component installed in the vehicle and measuring the internal light intensity of the vehicle, and may be installed on a portion of the rear mirror frame 20 for example.

The control unit 13 may adjust the light transmittance and light reflectivity of the liquid crystal mirror unit 400 by comparing the light intensities respectively measured by the plurality of light sensors 31, 32, and 33 installed at the vehicle, thereby controlling the mirror mode and the LCD mode to be automatically switched. However, the present disclosure is not necessarily limited thereto. That is, the mirror mode and the LCD mode may also be provided for the user to manually switch the modes through a separately provided manual manipulation lever 14. The control unit 13 may function to automatically and/or manually switch between the mirror mode and the LCD mode on its own, or may include a separate drive switching unit (not shown) provided to perform this function.

In the embodiments, the drive switching unit may be controlled to automatically switch a drive mode from the mirror mode to the LCD mode by the control unit 13 when receiving a reverse gear signal of the vehicle.

The control system for the digital rear mirror device according to the embodiments of the present disclosure may further include an LC mirror drive unit 16, an LED drive unit 17, and an LCD drive unit 18. The LC mirror drive unit 16 may be a component for driving and controlling an LC mirror 21, and each of the LED drive unit 17 and the LCD drive unit 18 may be a component for driving and controlling an LCD module 22. Here, the LC mirror 21 may be a component corresponding to the liquid crystal mirror unit 400 described above with reference to FIGS. 2 and 3, and the LCD module 22 may be a component corresponding to the TFT array 200 described above with reference to FIGS. 2 and 3.

In the embodiments, the LC mirror drive unit 16 may function as a liquid crystal mirror adjustment unit for adjusting the light transmittance and light reflectivity of the liquid crystal mirror unit 400, and the liquid crystal mirror adjustment unit 16 may be provided to adjust the light transmittance and light reflectivity of the liquid crystal mirror unit stepwise in a plurality of stages by using a pulse width modulation (PWM) control manner.

Here, the pulse width modulation (PWM) control manner may be a manner of adjusting a pulse width, that is, a ratio of ON and OFF, to generate a desired output, and may be applied as a mechanism to transfer a desired amount of power to the liquid crystal cell by adjusting an ON time (pulse width) of the electric signal while rapidly repeating ON and OFF states. The pulse width modulation (PWM) control manner may be used to electrically adjust the transmittance and reflectivity of the liquid crystal cell by using a duty cycle, which is a percentage of time in which the electric signal is ON, and a PWM signal frequency, which indicates how often the ON and OFF states are repeated.

In an embodiment, the liquid crystal mirror adjustment unit 16 may be provided to adjust the light transmittance and light reflectivity of the liquid crystal mirror unit 400 in three or more stages by using the pulse width modulation (PWM) control manner.

For example, the light reflectivity of the liquid crystal mirror unit 400 may be adjusted stepwise over a first adjustment stage in which the light reflectivity of the liquid crystal mirror unit 400 is maintained at 40% or more, a second adjustment stage in which the light reflectivity of the liquid crystal mirror unit 400 is adjusted and maintained within a range of 15% or more and less than 40%, and a third adjustment stage in which the light reflectivity of the liquid crystal mirror unit 400 is maintained at less than 15%. The first adjustment stage may be a stage performed in the above-described first mirror mode, and the second and third adjustment stages may be stages performed in the above-described second mirror mode.

That is, the digital rear mirror device 1 according to the present disclosure may use the pulse width modulation (PWM) control manner to flexibly adjust the light reflectivity of the liquid crystal mirror unit 400 within the specific range.

The control system for the digital rear mirror device according to the embodiments of the present disclosure may further include a video processing unit 15, receive a video signal from a rear capturing unit 40 installed on the rear side of the vehicle, and then function to correct distortion on the received video and adjust its brightness or contrast.

In an embodiment, the TFT array 200 may be controlled to form and transmit the video received from the rear capturing unit 40 installed at the rear of the vehicle to the lower part of the screen of the display unit 10 of the digital rear mirror device 1 by the control unit 13 when the LCD mode is automatically switched by receiving the reverse gear signal of the vehicle.

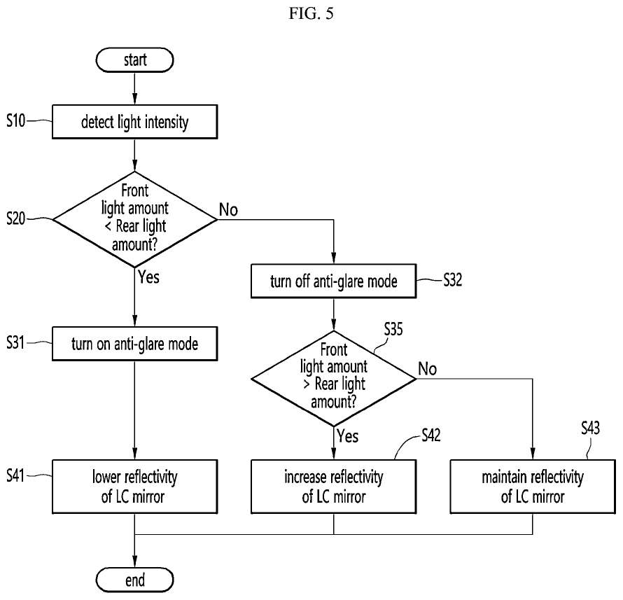

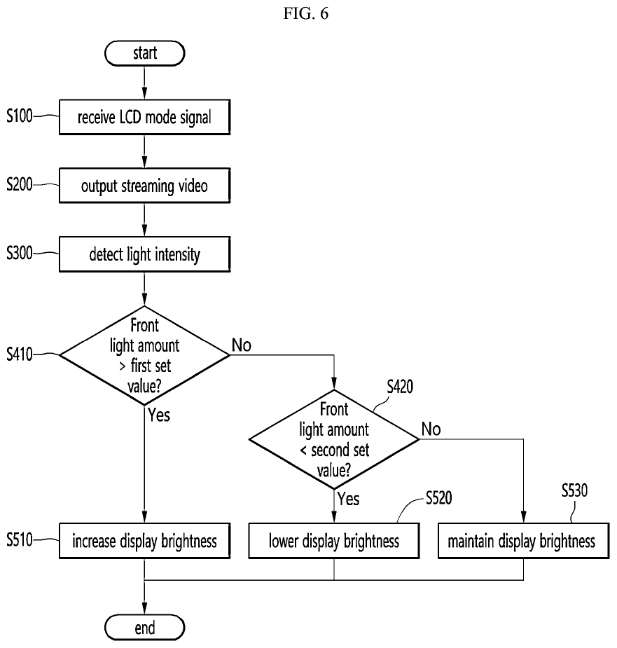

FIGS. 5 and 6 are flowcharts each showing a control method of a digital rear mirror device according to embodiments of the present disclosure.

Referring to FIG. 5, a control method of a digital rear mirror device having an anti-glare function according to the embodiments of the present disclosure relates to the control method of a digital rear mirror device 1 which includes the liquid crystal mirror unit 400 that uses a liquid crystal (LC) method. The method includes: detecting the light intensity from each of the front light sensor 31 and the rear light sensor 32 installed at the vehicle (S10); comparing the light intensity measured by the front light sensor 31 with the light intensity measured by the rear light sensor 32 (S20); driving an anti-glare mode based on a light intensity comparison result (S30); and adjusting the reflectivity of the liquid crystal mirror unit 400 (S40).

Here, the anti-glare mode may be controlled to be driven (S31) only when the light intensity measured by the rear light sensor 32 is determined to be stronger than the light intensity measured by the front light sensor 31 in the comparing of the light intensities (S20), and the anti-glare mode may be implemented by lowering the reflectivity of the liquid crystal mirror unit 400 to less than the predetermined value, for example, less than 40% (S41).

On the contrary, the anti-glare mode may be controlled not to be driven (S32) when the light intensity measured by the front light sensor 31 is determined to be stronger than the light intensity measured by the rear light sensor 32 or to be at the same or similar level in the comparing of the light intensities (S20). In this case, the method may further include additionally comparing the light intensity measured by the front light sensor 31 with the light intensity measured by the rear light sensor 32 (S35).

The reflectivity of the liquid crystal mirror unit 400 may be implemented to be increased to the predetermined value or more, for example, 15% or more (S42), when the light intensity measured by the front light sensor 31 is determined to be stronger than the light intensity measured by the rear light sensor 32 in the additionally comparing of the light intensities (S35), and the reflectivity of the liquid crystal mirror unit 400 may be controlled to be maintained to be the same as before when the light intensity measured by the front light sensor 31 and the light intensity measured by the rear light sensor 32 are determined to be at the same or similar level.

Referring to FIG. 6, a control method of a digital rear mirror device having an anti-glare function according to the embodiments of the present disclosure relates to the control method of a digital rear mirror device, which includes the liquid crystal mirror unit 400 that uses the liquid crystal (LC) method and is capable of implementing the mirror mode for checking the state of the rear of the vehicle through reflected light and the LCD mode for displaying the image or the video. The method includes: receiving the LCD mode signal (S100); outputting a streaming video (S200); detecting the light intensity from the front light sensor 31 installed at the vehicle (S300); comparing the light intensity measured by the front light sensor 31 with the predetermined value (S410); and adjusting the display brightness of the streaming video based on the light intensity comparison result (S500).

Here, the control unit 13 may perform the control to increase the brightness of the display unit 10 (S510) when the light intensity measured by the front light sensor 31 is greater than a first set value in the comparing of the light intensities (S410). The first set value may be, for example, a value between 1,000 lux and 2,000 lux.

Meanwhile, the method may further include additionally comparing the light intensity measured by the front light sensor 31 with a second set value (S420) when the light intensity measured by the front light sensor 31 is not greater than the first set value in the comparing of the light intensities (S410). The second set value may be, for example, a value between 300 lux and 500 lux.

The control unit 13 may perform the control to reduce the brightness of the display unit 10 (S520) when the light intensity measured by the front light sensor 31 is determined to be less than the second set value, and the control unit 13 may perform the control to maintain the brightness of the display unit 10 (S530) when the light intensity measured by the front light sensor 31 and the second set value are determined to be at the same or similar level, in the additionally comparing of the light intensities (S420).

As described above, the digital rear mirror device 1 having the anti-glare function according to the embodiments of the present disclosure may include the liquid crystal mirror unit 400 that uses the liquid crystal (LC) method, and may have a significantly improved response speed compared to the digital rear mirror that uses the existing electronic chromic (EC) method to thus immediately adjust the brightness based on a fast response speed to an external lighting change, thus rapidly inhibiting driver glare, thereby minimizing the driver's eye fatigue.

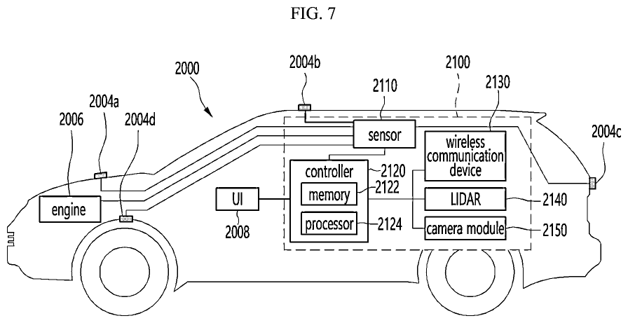

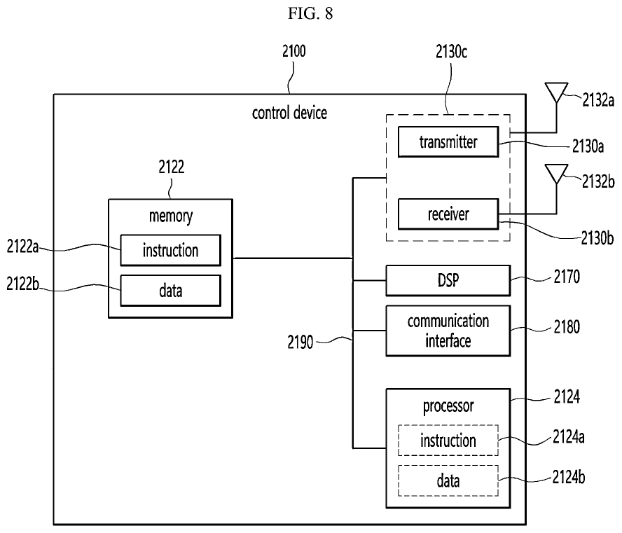

FIG. 7 is a block diagram showing a vehicle 2000 mounted with the digital rear mirror device 1 according to embodiments of the present disclosure. FIG. 8 is a block diagram showing a control device 2100 of the vehicle in FIG. 7 that controls the digital rear mirror device 1.

Referring to FIGS. 7 and 8, the vehicle 2000 may be mounted with a digital rear mirror system 100 according to the various embodiments, and may include the control device 2100. Here, the vehicle 2000 may be an autonomous vehicle. In some embodiments, at least one component of a camera device 110 or at least one component of a digital rear mirror device 120 may be integrated into at least one component of the control device 2100.

The control device 2100 may include a controller 2120 including a memory 2122 and a processor 2124, a sensor 2110, a wireless communication device 2130, a light detection and ranging (LIDAR) device 2140, and a camera module 2150.

The controller 2120 may be configured by a manufacturer of the vehicle at the time of manufacture or may be further configured after the manufacture to perform an autonomous driving function. Alternatively, the controller 2120 configured at the time of manufacture may be upgraded to include a configuration for performing a continuous additional function.

The controller 2120 may transmit a control signal to other components within the vehicle, including the sensor 2110, an engine 2006, a user interface (UI) 2008, the wireless communication device 2130, the LIDAR device 2140, and the camera module 2150. In addition, although not shown, the controller 2120 may also transfer the control signal to an accelerator, a braking system, a steering device, or a navigation device, associated with the driving of the vehicle.

The controller 2120 may control the engine 2006. For example, the controller 2120 may detect a speed limit of a road on which the vehicle 2000 drives, control the engine 2006 for a driving speed not to exceed the speed limit, or control the engine 2006 to accelerate the driving speed of the vehicle 2000 within a range that does not exceed the speed limit. In addition, when a sensing module 2004a, 2004b, 2004c, or 2004d detects an external environment of the vehicle and transfers information on the external environment to the sensor 2110, the controller 2120 may receive this information and generate a signal to control the engine 2006 or the steering device (not shown), thereby controlling the driving of the vehicle.

The controller 2120 may control the engine 2006 or the braking system to decelerate the driving vehicle when another vehicle or an obstacle exists in front of the vehicle, and control the trajectory, driving path, and steering angle of the vehicle in addition to its speed. Alternatively, the controller 2120 may control the driving of the vehicle by generating a necessary control signal based on recognition information of other external environments such as the driving lane marking and driving signal of the vehicle.

The controller 2120 may also control the driving of the vehicle by communicating with a surrounding vehicle or a central server in addition to generating its own control signal, and transmitting an instruction to control a surrounding device based on the received information.

In addition, it may be difficult to accurately recognize the vehicle or the lane marking when changing the position or angle of view of the camera module 2150. Therefore, the controller 2120 may generate the control signal to control calibration of the camera module 2150 to inhibit this difficulty. Therefore, the controller 2120 may generate the calibration control signal to the camera module 2150, thereby continuously maintaining the normal mounting position, direction, angle of view, or the like of the camera module 2150 even if the mounting position of the camera module 2150 is changed due to vibration or impact caused by a movement of the autonomous vehicle 2000. The controller 2120 may generate the control signal to perform the calibration of the camera module 2150 when the pre-stored initial mounting position, direction, or angle of view information of the camera module 2150 and the initial mounting position, direction, angle of view information, or the like of the camera module 2150 that is measured during the driving of the autonomous vehicle 2000 are different from each other by a threshold value or more.

The controller 2120 may include the memory 2122 and the processor 2124. The processor 2124 may execute software stored in the memory 2122 based on the control signal of the controller 2120. In detail, the controller 2120 may store, in the memory 2122, data and instructions for securing the rear view from the rear video of the vehicle 2000, and the instructions may be executed by the processor 2124 to implement one or more methods disclosed herein.

Here, the memory 2122 may be stored on a non-volatile storage medium executable by the processor 2124. The memory 2122 may store software and data through an appropriate internal or external device. The memory 2122 may include the memory device 2122 connected to a random access memory (RAM), a read only memory (ROM), a hard disk, or a dongle.

The memory 2122 may store at least an operating system (OS), a user application, and executable instructions. The memory 2122 may also store application data and array data structures.

The processor 2124 may be a microprocessor or a suitable electronic processor, the controller, a microcontroller, or a state machine.

The processor 2124 may be implemented as a combination of computing devices, and the computing device may be a digital signal processor, the microprocessor, or a suitable combination thereof.

In addition, the control device 2100 may monitor an internal or external feature of the vehicle 2000 and detect its state by using at least one sensor 2110.

The sensor 2110 may include at least one sensing module 2004, and the sensing module 2004 may be disposed at a specific position of the vehicle 2000 based on a detection purpose. The sensing module 2004 may be disposed at the bottom, rear, front, top, or side of the vehicle 2000, and also be disposed at the internal part, tire, or the like of the vehicle.

In this way, the sensing module 2004 may detect driving information, such as the engine 2006, tire, steering angle, speed, and weight of the vehicle, as internal information of the vehicle. In addition, at least one sensing modules 2004 may include an accelerometer sensor 2110, a gyroscope, an image sensor 2110, a radio detection and ranging (RADAR) device, an ultrasonic sensor, the LIDAR device, or the like, and may detect movement information of the vehicle 2000.

The sensing module 2004 may also receive specific data on a state of the external environment, such as information on a state of a road where the vehicle 2000 is disposed, information on the surrounding vehicle, and the weather, and detect a parameter of the vehicle based thereon. The detected information may be stored in the memory 2122 for a short or long term based on the purpose.

The sensor 2110 may collect and integrate information from the sensing modules 2004 for collecting information generated inside and outside the vehicle 2000.

The control device 2100 may further include the wireless communication device 2130.

The wireless communication device 2130 may be configured to implement wireless communication of the vehicle 2000. For example, the wireless communication device 2130 may enable the vehicle 2000 to communicate with a user mobile phone, or another wireless communication device 2130, another vehicle, a central device (traffic control device), a server, or the like. The wireless communication device 2130 may transmit and receive a wireless signal according to a wireless access protocol. The wireless communication protocol may be wireless-fidelity (Wi-Fi), Bluetooth, long-term evolution (LTE), code division multiple access (CDMA), wideband code division multiple access (WCDMA), or global systems for mobile communications (GSM), and is not limited thereto.

In addition, the vehicle 2000 may also implement inter-vehicle communication through the wireless communication device 2130. That is, the wireless communication device 2130 may communicate with another vehicle or other vehicles on the road based on vehicle-to-vehicle (V2V) communication. The vehicle 2000 may transmit and receive information such as driving warnings and traffic information through the vehicle-to-vehicle communication, and request information or receive a request from other vehicles. For example, the wireless communication device 2130 may perform the V2V communication by using a dedicated short-range communication (DSRC) device or a cellular-V2V (C-V2V) device. In addition, the wireless communication device 2130 may also implement communication (vehicle to everything (V2X) communication) between the vehicle and another object (for example, an electronic device carried by a pedestrian) in addition to the communication between the vehicles.

In addition, the control device 2100 may include the LIDAR device 2140. The LIDAR device 2140 may detect a surrounding object of the vehicle 2000 during its operation by using data sensed by a LIDAR sensor. The LIDAR device 2140 may transmit detected information to the controller 2120, and the controller 2120 may operate the vehicle 2000 based on the detected information. For example, the controller 2120 may instruct the vehicle to reduce its speed using the engine 2006 when the detection information indicates a slow-moving vehicle ahead. Alternatively, the controller 2120 may instruct the vehicle to reduce its entry speed based on a curvature of the curve into which the vehicle enters.

The control device 2100 may further the camera module 2150. The control device 2100 may extract object information from an external image captured by the camera module 2150, and cause the controller 2120 to process the information.

In addition, the control device 2100 may further include an imaging device for recognizing the external environment. The control device 2100 may use the RADAR device, a global positioning system (GPS) device, a driving distance measurement device (Odometry), or another computer vision device in addition to the LIDAR device 2140, and these devices may be operated selectively or simultaneously as needed to enable more precise detection.

The vehicle 2000 may further include the user interface 2008 for a user input to the control device 2100 described above. The user interface 2008 may allow the user to input information through appropriate interaction. For example, the user interface 2008 may be implemented as a touch screen, a keypad, the manipulation button, or the like. The user interface 2008 may transmit the user input or command to the controller 2120, and the controller 2120 may perform a vehicle control operation in response to the input or command.

In addition, the user interface 2008 may allow the vehicle 2000 to communicate with a device outside the vehicle 2000 through the wireless communication device 2130. For example, the user interface 2008 may enable the vehicle 2000 to interact with the mobile phone, a tablet, or another computing device.

Furthermore, although the vehicle 2000 is described as including the engine 2006, the vehicle 2000 may also include a different type of propulsion system. For example, the vehicle may be powered by electric energy, hydrogen energy, or a hybrid system combining the two energies. Therefore, the controller 2120 may include a propulsion mechanism based on a propulsion system of the vehicle 2000, and provide the control signal based thereon to each component of the propulsion mechanism.

Hereinafter, referring to FIG. 8, the description describes in more detail a detailed configuration of the control device 2100 that controls the digital rear mirror device 1 for implementing the mirror mode for checking the state of the rear of the vehicle through reflected light and the LCD mode for displaying the image or the video.

The control device 2100 may include the processor 2124. The processor 2124 may be a general-purpose single or multi-chip microprocessor, a dedicated microprocessor, the microcontroller, a programmable gate array, or the like. The processor may be referred to as a central processing unit (CPU). In addition, the processor 2124 may also be used in a combination of the plurality of processors.

The control device 2100 may also include the memory 2122. The memory 2122 may be any electronic component capable of storing electronic information. The memory 2122 may also include a combination of the memories 2122 in addition to a single memory.

According to the various embodiments, the memory 2122 may also store data and instructions 2122a for securing the rear view from the rear video of the vehicle 2000. When the processor 2124 executes the instructions 2122a, all or part of the instructions 2122a and data 2122b necessary to perform the instructions may be loaded into instructions 2124a and data 2124b of the processor 2124.

The control device 2100 may also include a transmitter 2130a, a receiver 2130b, or a transceiver 2130c to allow transmission and reception of signals. One or more antennas 2132a and 2132b may be electrically connected to the transmitter 2130a, the receiver 2130b, or each transceiver 2130c, and may also include additional antennas.

The control device 2100 may also include a digital signal processor (DSP) 2170. The control device 2100 may enable the vehicle to rapidly process a digital signal by using the DSP 2170.

The control device 2100 may also include a communication interface 2180. The communication interface 2180 may include one or more ports and/or communication modules for connecting other devices to the control device 2100. The communication interface 2180 may enable the user to interact with the control device 2100.

The various components of the control device 2100 may be connected with each other by one or more buses 2190, and the buses 2190 may include a power bus, a control signal bus, a state signal bus, a data bus, and the like. The components may communicate information to each other through the bus 2190 and each perform an intended function under the control of the processor 2124.

The digital rear mirror device 1 according to the present disclosure may be provided to compare the light intensities respectively measured by the front light sensor 31 and the rear light sensor 32 to thus adjust the light transmittance and light reflectivity of the liquid crystal mirror unit 400, thereby implementing the anti-glare function, and adjust the anti-glare function stepwise in the plurality of stages by the light transmittance and light reflectivity of the liquid crystal mirror unit 400 in the pulse width modulation (PWM) control manner, thereby providing the driver with improved driving convenience, and maximized visibility in various traffic situations.

In addition, the digital rear mirror device 1 according to the present disclosure may control the liquid crystal arrangement in a pixel unit by precisely driving the TFT array 200 to thus precisely display the rear video based on the surrounding light or a driving situation, thus allowing the driver to be always provided with a secured clear and sharp rear view, and the maximized visibility in various environments such as day and night.

In addition, the digital rear mirror device 1 according to the present disclosure may easily perform the switch between the general mirror mode and the LCD mode for streaming the image or the video, either manually or automatically, and automatically adjust the display brightness in the LCD mode based on the surrounding light, such as day or night and bright environment or the dark environment, thereby always maintaining the optimal field of vision without the driver's direct brightness adjustment.

However, the present disclosure is not necessarily limited thereto, and the devices/methods/systems according to the embodiments of the present disclosure may be applied to various products/technology fields in addition to the products/technology fields mentioned above.

Although the various embodiments of the present disclosure have been specifically described above, those skilled in the art to which the present disclosure pertains may appreciate that the embodiments described above may be changed in various ways without departing from the scope of the present disclosure. Accordingly, the scope of the present disclosure is not construed as being limited to the described embodiments, and defined by the appended claims as well as equivalents thereto.

### DESCRIPTION OF REFERENCE NUMERALS IN THE DRAWINGS

1: Digital rear mirror device
10: Display unit
11: Power supply unit
12: Power system
13: Control unit
14: Manual manipulation lever
15: Video processing unit
16: LC mirror drive unit
17: LED drive unit
18: LCD drive unit
20: Rear mirror frame
21: LC mirror
22: LCD module
31: Front light sensor
32: Rear light sensor
33: Internal light sensor
40: Rear capturing unit
100: Backlight unit
200: TFT array
210: Thin film transistor
220: Color filter
230: LCD polarizing plate
300: Rear polarizing mirror
400: Liquid crystal mirror unit
411: First polarizing unit
412: First ITO glass
421: Second polarizing unit
422: Second ITO glass
430: Liquid crystal cell
500: Front polarizing mirror
600: Cover lens

1. A digital rear mirror device having an anti-glare function, which is capable of implementing a mirror mode for checking a state of a rear of a vehicle through reflected light and a liquid crystal display (LCD) mode for displaying an image or a video, the device comprising:
a cover lens for transmitting light from the front;
a backlight unit for providing light from the rear;
a polarizing unit for aligning a light direction;
a liquid crystal mirror unit for adjusting and reflecting the light transmission;
a thin film transistor (TFT) array for providing an electrical signal required for implementing a display image or video;
a drive switching unit for switching between the mirror mode and the LCD mode; and
a control unit for adjusting the light transmittance and light reflectivity of the liquid crystal mirror unit by comparing light intensities measured by a plurality of light sensors installed at the vehicle.

2. The device of claim 1, wherein the mirror mode includes a first mirror mode in which the anti-glare function is not implemented and a second mirror mode in which the anti-glare function is implemented, and
the anti-glare function is driven by lowering the light reflectivity of the liquid crystal mirror unit to below a predetermined value by the control unit.

3. The device of claim 2, wherein the plurality of light sensors include a front light sensor for detecting and measuring the intensity of light entering from the front of the vehicle, and a rear light sensor for detecting and measuring the intensity of light entering from the rear of the vehicle, and
the control unit controls the first mirror mode and the second mirror mode to be selectively driven by comparing the light intensity measured by the front light sensor with the light intensity measured by the rear light sensor.

4. The device of claim 3, wherein the control unit controls the first mirror mode to be driven when the light intensity measured by the rear light sensor is weaker or equal to the light intensity measured by the front light sensor, and
controls the second mirror mode to be driven when the light intensity measured by the rear light sensor is stronger than the light intensity measured by the front light sensor.

5. The device of claim 2, wherein the light reflectivity of the liquid crystal mirror unit is adjusted to 40% or more in the first mirror mode, and
the light reflectivity of the liquid crystal mirror unit is adjusted to less than 40% in the second mirror mode.

6. The device of claim 3, wherein the light reflectivity of the liquid crystal mirror unit is adjusted to be within a range of 10% or more and less than 40% in the second mirror mode.

7. The device of claim 6, further comprising a liquid crystal mirror adjustment unit for adjusting the light transmittance and light reflectivity of the liquid crystal mirror unit,
wherein the liquid crystal mirror adjustment unit is provided to adjust the light transmittance and light reflectivity of the liquid crystal mirror unit stepwise in a plurality of stages by using a pulse width modulation (PWM) control manner.

8. The device of claim 1, wherein the drive switching unit is controlled to automatically switch a drive mode from the mirror mode to the LCD mode by the control unit when receiving a reverse gear signal of the vehicle, and
the TFT array is controlled to form and transmit video received from a rear camera installed at the rear of the vehicle to a lower part of a display screen of the digital rear mirror device by the control unit when the LCD mode is automatically switched by receiving the reverse gear signal of the vehicle.

9. A control method of a digital rear mirror device having an anti-glare function, which includes a liquid crystal mirror unit that uses a liquid crystal (LC) method, the method comprising:
detecting light intensity from each of a front light sensor and a rear light sensor, installed on a vehicle;
comparing the light intensity measured by the front light sensor with the light intensity measured by the rear light sensor;
driving an anti-glare mode based on a light intensity comparison result; and
adjusting reflectivity of the liquid crystal mirror unit.

10. The method of claim 9, wherein the anti-glare mode is controlled to be driven only when the light intensity measured by the rear light sensor is determined to be stronger than the light intensity measured by the front light sensor in the comparing of the light intensities.

11. The method of claim 10, wherein the anti-glare mode is implemented by lowering the reflectivity of the liquid crystal mirror unit to less than a predetermined value.

12. The method of claim 9, wherein the anti-glare mode is controlled not to be driven when the light intensity measured by the front light sensor is determined to be stronger than the light intensity measured by the rear light sensor or to be in the same or similar level in the comparing of the light intensities.

13. The method of claim 12, further comprising additionally comparing the light intensity measured by the front light sensor with the light intensity measured by the rear light sensor,
wherein the additionally comparing of the light intensities is controlled to be performed only when the light intensity measured by the front light sensor in the comparing of the light intensities is determined to be stronger than the light intensity measured by the rear light sensor or to be in the same or similar level.

14. The method of claim 13, wherein the reflectivity of the liquid crystal mirror unit is controlled to be increased to a predetermined value or more when the light intensity measured by the front light sensor is determined to be stronger than the light intensity measured by the rear light sensor in the additionally comparing of the light intensities.

15. The method of claim 13, wherein the reflectivity of the liquid crystal mirror unit is controlled to be maintained to be the same as before when the light intensity measured by the front light sensor and the light intensity measured by the rear light sensor are determined to be at the same or similar level in the additionally comparing of the light intensities.

16. A control method of a digital rear mirror device having an anti-glare function, which includes a liquid crystal mirror unit that uses a liquid crystal (LC) method, and is capable of implementing a mirror mode for checking a state of a rear of a vehicle through reflected light and a liquid crystal display (LCD) mode for displaying an image or a video, the method comprising:
receiving an LCD mode signal;
outputting a streaming video;
detecting light intensity from a front light sensor installed on the vehicle;
comparing the light intensity measured by the front light sensor with a predetermined value; and
adjusting display brightness of the streaming video based on a light intensity comparison result.

17. The method of claim 16, wherein in the comparing of the light intensities, the light intensity measured by the front light sensor is compared with a first set value between 1,000 lux and 2,000 lux, and
the display brightness of the streaming video is controlled to be increased when the light intensity measured by the front light sensor is determined to be greater than the first set value in the comparing of the light intensities.

18. The method of claim 17, further comprising additionally comparing the light intensity measured by the front light sensor with a second set value between 300 lux and 500 lux,
wherein the additionally comparing of the light intensities is performed only when the light intensity measured by the front light sensor is determined to be the first set value or less.

19. The method of claim 18, wherein the display brightness of the streaming video is controlled to be reduced when the light intensity measured by the front light sensor is determined to be less than the second set value in the additionally comparing of the light intensities.

20. The method of claim 18, wherein the display brightness of the streaming video is controlled to be maintained when the light intensity measured by the front light sensor and the second set value are determined to be at the same or similar level in the additionally comparing of the light intensities.
